(19) United States
(12) Patent Application Publication
(10) Pub. No.: US 2026/0122755 A1
(43) Pub. Date: Apr. 30, 2026

(54) Resonator Coil Frequency Vibration Control

(71) Applicant: Applied Materials, Inc., Santa Clara, CA (US)

(72) Inventors: Luke Bonecutter, Cedar Park, TX (US); Krag Raymond Senior, Austin, TX (US); Jonathan Daniel Moore, Georgetown, TX (US); David Blahnik, Round Rock, TX (US); Jack Joseph LoPiccolo, Gloucester, MA (US); Colton Rhoades, Austin, TX (US)

(21) Appl. No.: 18/929,148

(22) Filed: Oct. 28, 2024

(51) Int. Cl. H05H 7/02

(52) U.S. Cl. CPC H05H 7/02; H05H 2007/025; H05H 2242/10

(57) ABSTRACT

An ion implanter that includes a plurality of RF resonator cavities is disclosed. Each RF resonator cavity includes a resonator coil. A cooling fluid is passed through the resonator coil. A sensor or transducer is used to measure a parameter of the cooling fluid, such as flow rate or pressure, as it exits the cooling fluid source. The measured parameter is then used by a vibration control system to control an actuator assembly located near the resonator coil. The actuator assembly is used to reduce the variations in the parameter, as experienced by the resonator coil. This system may reduce the amount of frequency vibration that the resonator coil experiences.

### FIELD

Embodiments of the present disclosure relate to a system and method to control vibrations of the resonator coil within a linear accelerator.

### BACKGROUND

One apparatus that is used to implant ions into workpieces is known as a linear accelerator or LINAC. The LINAC operates by accelerating bunches of ions by passing them through a series of electrodes. These electrodes are biased using oscillating voltages such that the ions are accelerated toward the electrodes as they are approaching, and then repelled as they pass the electrode.

Each electrode is electrically connected to a respective resonator coil. This resonator coil is disposed within an RF resonator cavity, along with a excitation coil. The RF resonator cavity is typically a sealed container made of a metal. Energy is supplied to the excitation coil, which causes an induced voltage in the resonator coil. This RF resonator cavity is typically grounded, while the coils may be driven with sinusoidal waveforms.

The induced voltage in the resonator coil tends to heat the coil. Therefore, in some embodiments, the resonator coil is cooled to control its temperature. This may be done by passing a cooling fluid through the interior of the coil. This cooling fluid may pass through a pump or chiller before passing through the resonator coil. In certain embodiments, the flow of the cooling fluid through the pump or chiller is not uniform. The variation in flow rate or pressure may cause vibrations of the resonator coil. These vibrations may be detrimental to the operation of the linear accelerator.

Therefore, it would be beneficial if there was a system and method to introduce a cooling fluid to the resonator coil without creating vibrations. Further, it would be advantageous if this system was easily implemented on existing linear accelerators.

### SUMMARY

An ion implanter that includes a plurality of RF resonator cavities is disclosed. Each RF resonator cavity includes a resonator coil. A cooling fluid is passed through the resonator coil. A sensor or transducer is used to measure a parameter of the cooling fluid, such as flow rate or pressure, as it exits the cooling fluid source. The measured parameter is then used by a vibration control system to control an actuator assembly located near the resonator coil. The actuator assembly is used to reduce the variations in the parameter, as experienced by the resonator coil. This system may reduce the amount of frequency vibration that the resonator coil experiences.

According to one embodiment, an ion implanter is disclosed. The ion implanter comprises an ion source; and a linear accelerator, comprising: one or more RF resonator cavities, wherein a resonator coil is disposed in each respective RF resonator cavity, wherein the resonator coil includes two or more internal channels to allow flow of a cooling fluid through the resonator coil; a cooling fluid source; an inlet tube to allow flow of the cooling fluid from the cooling fluid source to a first of the two or more internal channels; an outlet tube connecting a second of the two or more internal channels to the cooling fluid source so that the cooling fluid circulates through the cooling fluid source, the inlet tube, the resonator coil, and the outlet tube; a transducer disposed on or in the inlet tube to measure a parameter of the cooling fluid exiting the cooling fluid source; an actuator assembly in communication with the inlet tube to vary the parameter of the cooling fluid before it enters the resonator coil; and a vibration controller in communication with the transducer to receive the parameter and to control the actuator assembly. In some embodiments, the parameter comprises pressure. In some embodiments, the parameter comprises flow rate. In some embodiments, the actuator assembly comprises a diaphragm disposed within a cavity and an actuator, wherein actuation of the actuator causes movement of the diaphragm, which changes a volume of the cavity. In some embodiments, the actuator assembly comprises an electronically controlled valve which varies a flow rate of cooling fluid passing therethrough. In some embodiments, the parameter varies in a periodic fashion at a frequency. In certain embodiments, the actuator assembly comprises a vibratory assembly to cancel the frequency. In certain embodiments, the frequency is between 2 Hz and 60 Hz. In some embodiments, a temperature sensor is used to monitor a temperature of the cooling fluid, wherein an output from the temperature sensor is supplied to the vibration controller. In some embodiments, the vibration controller uses a proportional control system to control the actuator assembly. In some embodiments, the vibration controller uses a proportional-derivative (P-D), a proportional-integral (P-I) or a proportional-integral-derivative (P-I-D) control system to control the actuator assembly.

According to another embodiment, an ion implanter is disclosed. The ion implanter comprises an ion source; and a linear accelerator, comprising: one or more RF resonator cavities, wherein a resonator coil is disposed in each respective RF resonator cavity, wherein the resonator coil includes two or more internal channels to allow flow of a cooling fluid through the resonator coil; a cooling fluid source; and a vibration control system disposed between the cooling fluid source and the resonator coil to reduce variations in flow rate or pressure of the cooling fluid exiting the cooling fluid source before the cooling fluid enters the resonator coil. In some embodiments, the variations are at a frequency between 2 Hz and 60 Hz. In some embodiments, the vibration control system comprises: a transducer to measure the flow rate or pressure of the cooling fluid exiting the cooling fluid source; an actuator assembly to modify the flow rate or pressure of the cooling fluid before the cooling fluid enters the resonator coil; and a vibration controller in communication with the transducer and the actuator assembly. In certain embodiments, a temperature sensor is used to monitor a temperature of the cooling fluid, wherein an output from the temperature sensor is supplied to the vibration controller. In certain embodiments, the vibration controller uses a proportional control system to control the actuator assembly. In certain embodiments, the vibration controller uses a proportional-derivation (P-D), a proportional-integral (P-I) or proportional-integral-derivative (P-I-D) control system to control the actuator assembly.

### BRIEF DESCRIPTION OF THE FIGURES

For a better understanding of the present disclosure, reference is made to the accompanying drawings, which are incorporated herein by reference and in which:

FIG. 1 shows an ion implanter that may utilize the control system described herein;

FIG. 2 shows the vibration control system according to one embodiment; and

FIG. 3 shows the actuator assembly according to one embodiment.

### DETAILED DESCRIPTION

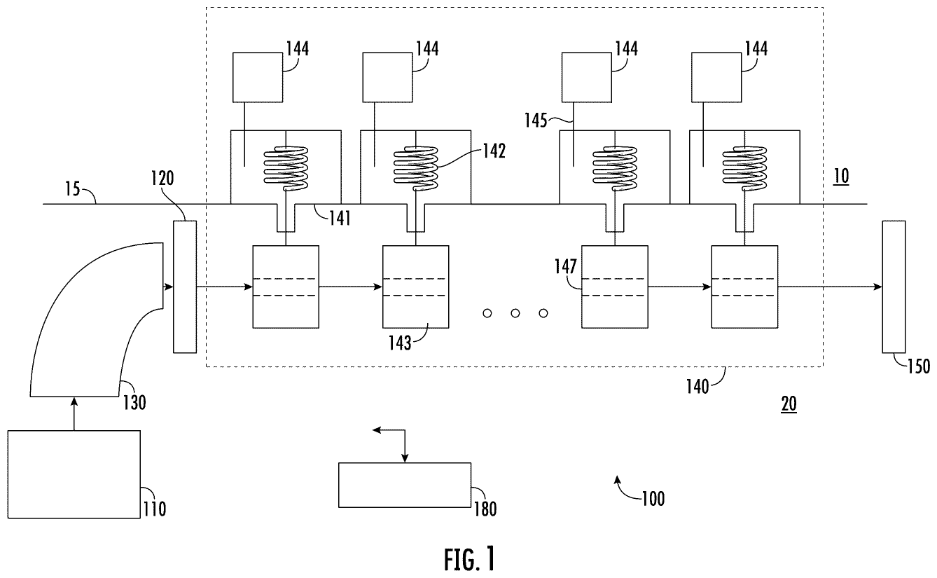

The control system that controls the cooling fluid passing through a resonator coil may be used as part of an ion implanter. FIG. 1 shows one such ion implanter 100. An ion source 110, a mass analyzer 130, a buncher 120 and portions of a linear accelerator 140 are disposed within the vacuum chamber 20, defined by a chamber wall 15. The ion source 110 may be any suitable ion source, such as, but not limited to, an indirectly heated cathode (IHC) source, a Bernas source, a capacitively coupled plasma source, an inductively coupled plasma source, or any other suitable device. The ion source 110 has an aperture through which ions may be extracted from the ion source 110. These ions may be extracted from the ion source 110 by applying a negative voltage to one or more electrodes, disposed outside the ion source 110, proximate the extraction aperture.

The ions may then enter a mass analyzer 130, which may be a magnet that allows ions having a particular mass to charge ratio to pass through. This mass analyzer 130 is used to separate the desired ions such that it is only the desired ions that then enter the linear accelerator 140.

The desired ions then enter a buncher 120, which creates groups or bunches of ions that travel together. The buncher 120 may comprise a plurality of drift tubes, wherein at least one of the drift tubes may be supplied with an AC voltage. One or more of the other drift tubes may be grounded. The drift tubes that are supplied with the AC voltage may serve to accelerate and manipulate the ion beam into discrete bunches.

The linear accelerator 140 comprises one or more RF resonator cavities 141. In certain embodiments, there may be between one and sixteen RF resonator cavities 141 in the linear accelerator 140. As shown in FIG. 1, a portion of the RF resonator cavity 141 may be disposed within the vacuum chamber 20, while other portions of the RF resonator cavity 141 are disposed in the atmospheric environment 10.

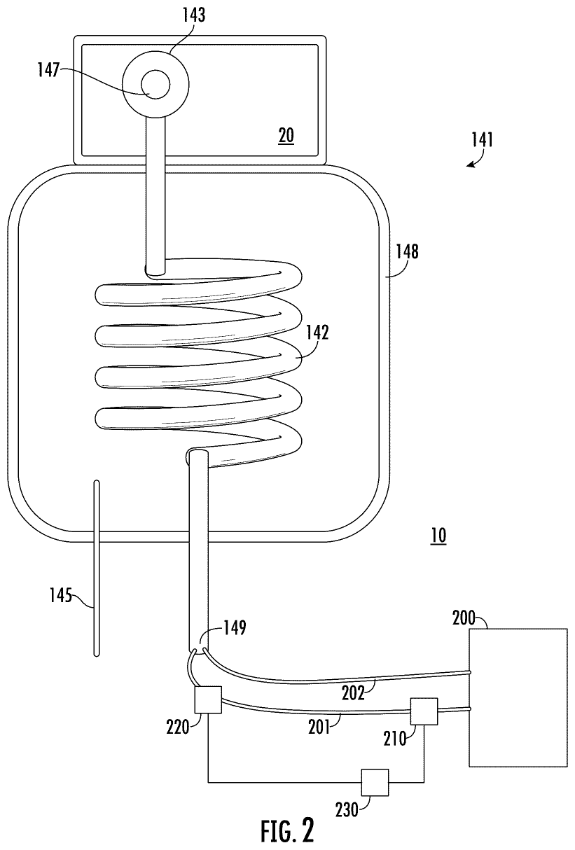

Each RF resonator cavity 141 may be a sealed container 148 (see FIG. 2). Within each container is a resonator coil 142 that may be energized by electromagnetic fields created by an excitation coil 145. The resonator coil 142 may be formed of a conductive material, such as copper. The resonator coil 142 includes at least two interior channels which are used to transport cooling fluid through the resonator coil 142. The entry and exit of the cooling fluid is typically disposed in the atmospheric environment 10.

The excitation coil 145 is also disposed in the RF resonator cavity 141 with a respective resonator coil 142. The excitation coil 145 is energized by an excitation voltage, which may be a RF signal. The excitation voltage may be supplied by a respective RF generator 144. Each excitation coil 145 is tuned to a single resonant frequency. In other words, the excitation voltage applied to each excitation coil 145 may be independent of the excitation voltage supplied to any other excitation coil 145. Each excitation voltage is preferably modulated at the resonance frequency of its respective excitation coil 145. The magnitude and phase of the excitation voltage may be determined and changed by a controller 180, which is in communication with the RF generator 144. By adjusting the driving RF power to the resonator coil 142 in an RF resonator cavity 141, the magnitude of the excitation voltage may be increased and/or the phase shifted

When RF power is applied to the excitation coil 145, a voltage is induced on the resonator coil 142. The RF power may have a frequency between 13.56 MHz and 40.68 MHz. Further, the amplitude of the induced voltage may be between 9 kV and 170 kV. The result is that the resonator coil 142 in each RF resonator cavity 141 is driven by a sinusoidal voltage. Each resonator coil 142 may be in electrical communication with a respective accelerator electrode 143. The ions pass through apertures 147 located in each accelerator electrode 143.

The entry of the bunch into a particular accelerator electrode 143 is timed such that the potential of the accelerator electrode 143 is negative as the bunch approaches (for positive ions), but switches to positive as the bunch passes through the aperture 147 in the accelerator electrode 143. In this way, the bunch is accelerated as it enters the accelerator electrode 143 and is repelled as it exits. This results in an acceleration of the bunch. This process is repeated for each accelerator electrode 143 in the linear accelerator 140. Each accelerator electrode increases the acceleration of the ions and can be measured.

After the bunch exits the linear accelerator 140, it is implanted into the workpiece 150.

The ion implanter 100 may include other components, such as an electrostatic scanner to create a ribbon beam, quadrupole elements, additional electrodes to accelerate or decelerate the beam and other elements.

A controller 180 may be used to control the ion implanter 100. The controller 180 may include a processing unit and a memory device. The processing unit may be a microprocessor, a signal processor, a customized field programmable gate array (FPGA), or another suitable unit. This memory device may be a non-volatile memory, such as a FLASH ROM, an electrically erasable ROM or other suitable devices. In other embodiments, the memory device may be a volatile memory, such as a RAM or DRAM. The memory device comprises instructions that enable the controller 180 to control the linear accelerator 140.

FIG. 2 shows a first embodiment of an RF resonator cavity 141 that includes a vibration control system to regulate the flow rate and/or pressure of cooling fluid into the resonator coil 142.

In some embodiments, the proximal end 149 of the resonator coil 142 is disposed in the atmospheric environment 10. For example, a cooling fluid source 200 may be connected to the proximal end 149 of the resonator coil 142 to allow a cooling fluid to pass through the resonator coil 142. The resonator coil 142 includes at least two interior channels that are connected at a distal end inside the resonator coil 142 to allow the flow of cooling fluid from the cooling fluid source 200, through the inlet tube 201, through the interior of the resonator coil 142, through the outlet tube 202 and back to the cooling fluid source 200. The cooling fluid source 200 may be a heat exchanger, a chiller or another device. The cooling fluid source 200 may include a pump to allow the circulation of the cooling fluid as described above. A transducer 210 may be disposed on or in the inlet tube 201. The transducer 210 may be used to measure a parameter of the cooling fluid in the inlet tube 201. For example, the transducer 210 may measure the pressure and/or the flow rate of the cooling fluid. In certain embodiments, the transducer 210 may also be used to measure temperature as the speed of sound through water varies with temperature. The output from the transducer 210 is provided to a vibration controller 230. The transducer 210 may be a pressure transducer or may be a flow rate transducer.

The vibration controller 230 may include a processing unit and a memory device. The processing unit may be a microprocessor, a signal processor, a customized field programmable gate array (FPGA), or another suitable unit. This memory device may be a non-volatile memory, such as a FLASH ROM, an electrically erasable ROM or other suitable devices. In other embodiments, the memory device may be a volatile memory, such as a RAM or DRAM. The memory device comprises instructions that enable the vibration controller 230 to reduce the vibrations experienced by the resonator coil 142. Note that in some embodiments, the vibration controller 230 may be integrated into the controller 180, while in other embodiments, it may be a separate component.

An actuator assembly 220 is also disposed on or in the inlet tube 201 so as to control the flow of the cooling fluid. Thus, based on the parameter measured by the transducer 210, the vibration controller 230 controls the operation of the actuator assembly 220. For example, assume that the transducer 210 is used to measure pressure. If the pressure measured by the transducer 210 has an upward spike, the actuator assembly 220 may be controlled so as to reduce the pressure going into the resonator coil 142.

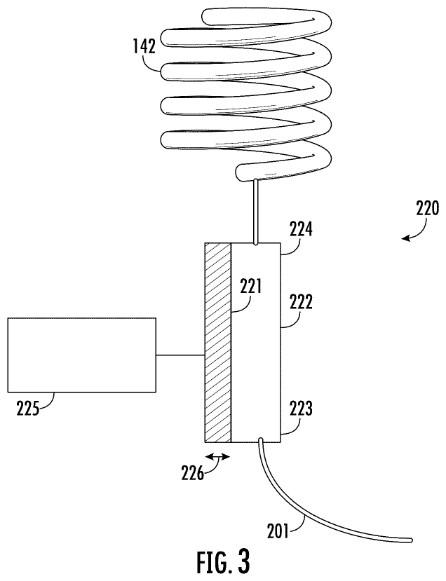

For example, FIG. 3 shows an embodiment of the actuator assembly 220. In this figure, the inlet tube 201 provides cooling fluid to a cavity 222. The first end 223 of the cavity 222 is in communication with the inlet tube 201, while the second end 224 of the cavity 222 is closer to the resonator coil 142. A diaphragm 221 is disposed within the cavity 222, and is movable along direction 226. Thus, movement of the diaphragm 221 changes the volume of the cavity 222. An actuator 225, such as a voice actuator, piezoelectric actuator or other type of actuator, is in communication with the diaphragm 221 so as to move the diaphragm 221. The actuator 225 receives an input signal or signals from the vibration controller 230, and based on that input signal or signals, moves the diaphragm 221. Thus, in the above example, if the transducer 210 detected that there was an increase in pressure, the vibration controller 230 would provide an input to the actuator 225 instructing the actuator 225 to move the diaphragm 221 so as to increase the volume of the cavity 222. This will have the effect of reducing the pressure of the cooling fluid entering the resonator coil 142. Similarly, if the transducer 210 measures flow rate, an increase in flowrate would also result in an expansion of the cavity 222 to reduce the flow rate.

Of course, the actuator assembly 220 may have other embodiments. For example, an electronically controlled valve may be used in place of the diaphragm 221 and cavity 222. In this example, the valve is used to control the flow of cooling fluid into the resonator coil 142. In another embodiment, the output from the chiller may be a pressure pulse that occurs in a periodic fashion, such as at a certain frequency. In this case, a vibratory mechanism may be used to cancel this frequency. For example, a motor with a counterweight mounted thereto may be attached to a metal housing through which the cooling fluid passes. The motor may be rotated at such an angular frequency so as to cancel the incoming pressure pulses.

The vibration controller 230 is responsible for controlling the actuator assembly 220. In one embodiment, a simple proportional control system is used, where a change in the measured parameter results in a proportional (positive or negative) change in the actuator assembly 220. In another embodiment, this control system also includes a phase delay to account for the distance between the location of the transducer 210 and the actuator assembly 220. The phase delay may be related to this distance as well as the average flow rate of the cooling fluid. In another embodiment, a more sophisticated control system may be used. For example, a P-D (proportional-derivative), a P-I (proportional-integral) or P-I-D (proportional-integral-derivative) control system may be implemented.

The embodiments described above in the present application may have many advantages. Cooling fluid sources, such as chillers and pumps, do not provide a constant flow rate and pressure of the cooling fluid. These changes in flow rate or pressure may cause a low frequency vibration of the resonator coil. In some systems, this low frequency vibration may be between 2 Hz and 60 Hz. This vibration leads to inefficiencies of the linear accelerator, in the form of increased reflected RF power. By detecting these changes in the parameters of the cooling fluid, and later compensating for them, the flow rate and pressure of the cooling fluid flowing through the resonator coil may be made more constant. This reduces the vibration experienced by the resonator coil, which improves the performance of the linear accelerator.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. An ion implanter, comprising:
an ion source; and
a linear accelerator, comprising:
one or more RF resonator cavities, wherein a resonator coil is disposed in each respective RF resonator cavity, wherein the resonator coil includes two or more internal channels to allow flow of a cooling fluid through the resonator coil;
a cooling fluid source;
an inlet tube to allow flow of the cooling fluid from the cooling fluid source to a first of the two or more internal channels;
an outlet tube connecting a second of the two or more internal channels to the cooling fluid source so that the cooling fluid circulates through the cooling fluid source, the inlet tube, the resonator coil, and the outlet tube;
a transducer disposed on or in the inlet tube to measure a parameter of the cooling fluid exiting the cooling fluid source;
an actuator assembly in communication with the inlet tube to vary the parameter of the cooling fluid before it enters the resonator coil; and
a vibration controller in communication with the transducer to receive the parameter and to control the actuator assembly.

2. The ion implanter of claim 1, wherein the parameter comprises pressure.

3. The ion implanter of claim 1, wherein the parameter comprises flow rate.

4. The ion implanter of claim 1, wherein the actuator assembly comprises a diaphragm disposed within a cavity and an actuator, wherein actuation of the actuator causes movement of the diaphragm, which changes a volume of the cavity.

5. The ion implanter of claim 1, wherein the actuator assembly comprises an electronically controlled valve which varies a flow rate of cooling fluid passing therethrough.

6. The ion implanter of claim 1, wherein the parameter varies in a periodic fashion at a frequency.

7. The ion implanter of claim 6, wherein the actuator assembly comprises a vibratory assembly to cancel the frequency.

8. The ion implanter of claim 6, wherein the frequency is between 2 Hz and 60 Hz.

9. The ion implanter of claim 1, further comprising a temperature sensor to monitor a temperature of the cooling fluid, wherein an output from the temperature sensor is supplied to the vibration controller.

10. The ion implanter of claim 1, wherein the vibration controller uses a proportional control system to control the actuator assembly.

11. The ion implanter of claim 1, wherein the vibration controller uses a proportional-derivative (P-D) control system to control the actuator assembly.

12. The ion implanter of claim 1, wherein the vibration controller uses a proportional-integral (P-I) control system to control the actuator assembly.

13. The ion implanter of claim 1, wherein the vibration controller uses a proportional-integral-derivative (P-I-D) control system to control the actuator assembly.

14. An ion implanter, comprising:
an ion source; and
a linear accelerator, comprising:
one or more RF resonator cavities, wherein a resonator coil is disposed in each respective RF resonator cavity, wherein the resonator coil includes two or more internal channels to allow flow of a cooling fluid through the resonator coil;
a cooling fluid source; and
a vibration control system disposed between the cooling fluid source and the resonator coil to reduce variations in flow rate or pressure of the cooling fluid exiting the cooling fluid source before the cooling fluid enters the resonator coil.

15. The ion implanter of claim 14, wherein the variations are at a frequency between 2 Hz and 60 Hz.

16. The ion implanter of claim 14, wherein the vibration control system comprises:
a transducer to measure the flow rate or pressure of the cooling fluid exiting the cooling fluid source;
an actuator assembly to modify the flow rate or pressure of the cooling fluid before the cooling fluid enters the resonator coil; and
a vibration controller in communication with the transducer and the actuator assembly.

17. The ion implanter of claim 16, further comprising a temperature sensor to monitor a temperature of the cooling fluid, wherein an output from the temperature sensor is supplied to the vibration controller.

18. The ion implanter of claim 16, wherein the vibration controller uses a proportional control system to control the actuator assembly.

19. The ion implanter of claim 16, wherein the vibration controller uses a proportional-derivation (P-D), a proportional-integral (P-I) or proportional-integral-derivative (P-I-D) control system to control the actuator assembly.
